(19) United States
(12) Patent Application Publication
(10) Pub. No.: US 2015/0018050 A1
(43) Pub. Date: Jan. 15, 2015

(54) HANDHELD ELECTRONIC DEVICE

(71) Applicant: HON HAI PRECISION INDUSTRY CO., LTD., New Taipei (TW)

(72) Inventor: KUANG-YAO LIAO, New Taipei (TW)

(21) Appl. No.: 14/324,223

(22) Filed: Jul. 6, 2014

(30) Foreign Application Priority Data
Jul. 8, 2013 (TW) 102124328

(51) Int. Cl. H04M 1/02

(52) U.S. Cl. CPC H04M 1/0277; H04M 1/026; H04M 2001/0204
USPC 455/573

(57) ABSTRACT

A handheld electronic device includes a housing, a display screen and a keypad assembly. The keypad assembly includes a FPC board, a number of press keys and a light guiding module. The press keys are held on the FPC board. The light guiding module includes a light guiding plate and a light source. The light guiding plate is mounted on the press keys. The light source is coupled to the FPC board and provides input light for the light guiding plate. The keypad structure further includes a receiving coil and a shielding layer. The receiving coil surrounds a periphery of the press keys. The receiving coil transfers electromagnetic waves into power, and charges the handheld electronic device. The shielding layer is laid on and adhered to the press keys. The light guiding plate is laid on and adhered to the shielding layers.

### FIELD

The subject matter herein generally relates to an electronic device, especially to a handheld electronic device which can be able to charge itself wirelessly.

### BACKGROUND

Handheld electronic device such as telephone always needs a battery to power itself. To power the electronic device effectively, the battery needs to keep fresh any time any where, so a charger is needed to carry so as to charger the battery.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a plain graph of an embodiment of a handheld electronic device.

FIG. 2 is a plain graph of a keypad assembly shown in FIG. 1.

FIG. 3 is a section view of a keypad assembly shown in FIG. 2 taken along line III-III.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “comprising,” when utilized, means “including, but not necessarily limited to”; it specifically indicates open-ended inclusion or membership in the so-described combination, group, series and the like.

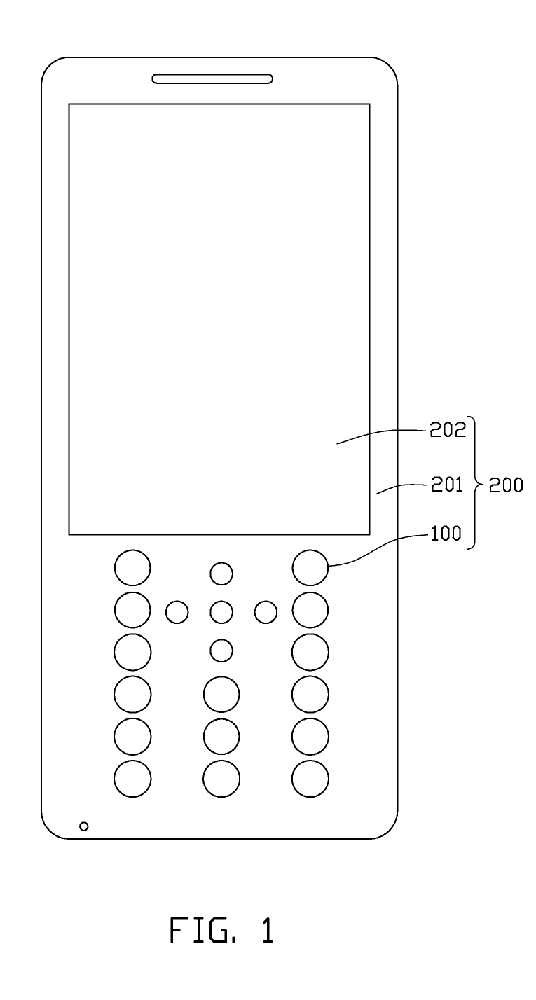

FIG. 1 is a plain graph of an embodiment of a handheld electronic device. The handheld electronic device 200 can include a housing 201, a display screen 202 mounted on the housing 201, and a keypad assembly 100 received in the housing 201.

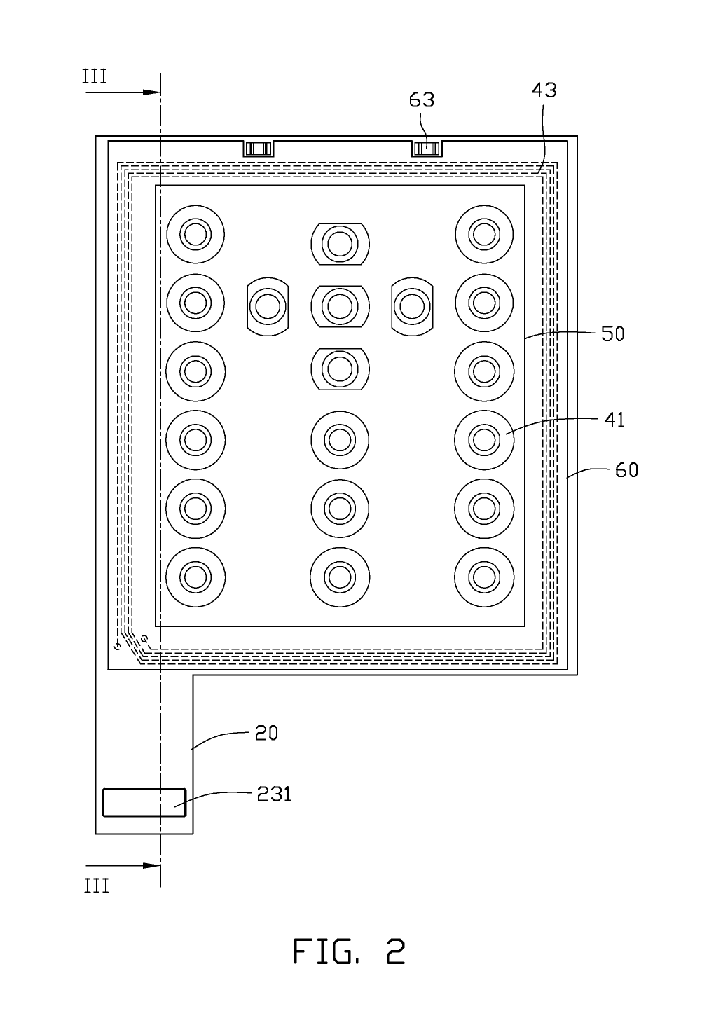

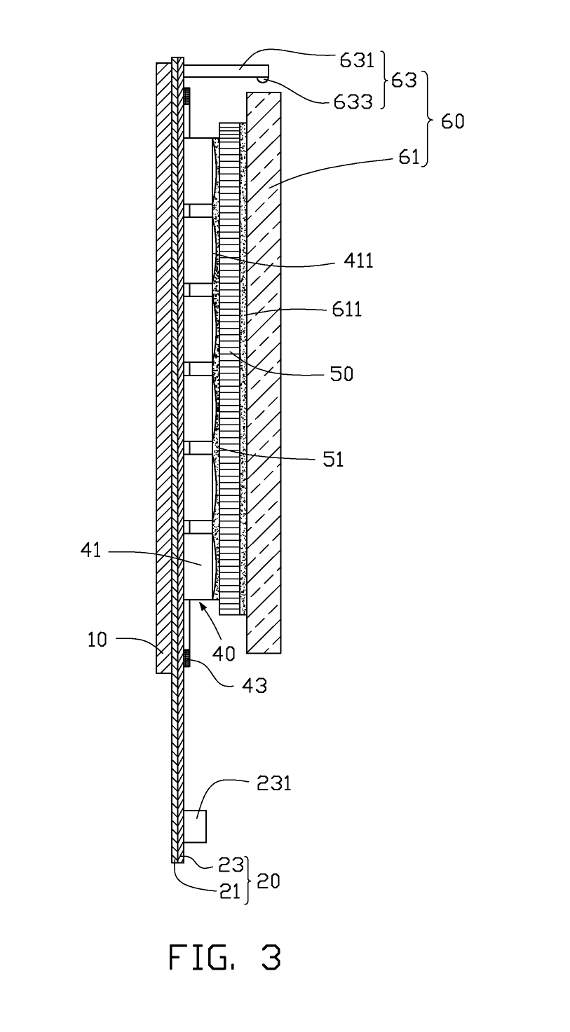

Referring to FIGS. 2 and 3. The keypad assembly 100 can include a basement layer 10, a flexible printed circuit board 20, a key layer 40, a shielding layer 50 and a light guiding module 60. Therein, the flexible printed circuit board 20, the key layer 40, the shielding layer 50 and the light guiding module 60 are held on a surface of the basement layer 10 which faces a front cover of the housing 201 in sequence. In this embodiment, the handheld electronic device 200 can be a telephone which has a chargeable battery (not labeled).

The basement layer 10 is made of insulating material. The flexible printed circuit board 20 is laid on the surface of the basement layer 10 and adhered to basement layer 10. In detail, the flexible printed circuit board 20 can include a circuit layer 21 and an insulation layer 23. The circuit layer 21 is laid on the basement layer 10 and adhered to basement layer 10, and the insulation layer 23 is laid on a surface of the circuit layer 21 away from the basement layer 10. The circuit layer 21 can include at least one circuit (not labeled). The insulation layer 23 is made of preimpregnation material and the insulation layer 23 can include a conductive pin 231. An electronic wire (not labeled) can pass through the insulation layer 2 and couples the conductive pin 231 with the chargeable battery of the handheld electronic device 200. In this embodiment, the basement layer 10 is rectangle.

The key layer 40 can include a number of press keys 41 and a receiving coil 43.

The press keys 41 are mounted to a surface of the insulation layer 23 away from the circuit layer 21. Each press key 41 can include a metal cover 411 located thereupon and a circuit located therein. The circuit of the each press key 41 is coupled to the circuit of the flexible printed circuit board 20 respectively. When a pressure is applied on one metal cover 411, the circuit of the press key 41 corresponding to the metal cover 411 and the circuit of the flexible printed circuit board 20 can be both triggered accordingly.

The receiving coil 43 can include a number of coils, and the coils can be coupled to a transmitting coil of an outer charger (not labeled). The receiving coil 43 is capable of receiving and transferring electromagnetic waves transmitted by the transmitting coil into power, and charges the chargeable battery of the handheld electronic device 200. The receiving coil 43 can be located on the surface of the insulation layer 23 away from the circuit layer 21, and surround a periphery of the number of press keys 41, and further couple the circuit of the circuit layer 21 with the conductive pin 231. In this embodiment, the receiving coil 43 is rectangle, and the receiving coil 43 can be electroplated or etched on the insulation layer 23.

The shielding layer 50 can be laid on and adhered to the number of press keys 41, and the shielding layer 50 can be glued to the press keys 41 via a glue layer 51 located there between. The shielding layer 50 can include a number of sections separated from each other. An area of an upper surface of each section of the shielding layer 50 is less than an area of an upper surface of the corresponding press key 41, so when a press is applied on one section of the shielding layer 50 which is corresponding to one press key 41, the corresponding press key 41 can be pressed with no influence to the other press keys 41.

In this embodiment, the area of the press keys 41 is 6-8 times of the area of the each section of the shielding layer 50. Of course, in at least one embodiment, a ratio between the area of the press key 41 and the section of the shielding layer 50 can be set according to the need.

In at least one embodiment, the shielding layer 50 can be an integrated flexible plate, so each press key 41 can be pressed individually with no influence to the other press keys 41.

The light guiding module 60 can include a light guiding plate 61 and a light source 63. The light guiding plate 61 is laid on a surface of the shielding layer 50 away from the press keys 41, and the light guiding plate 61 is glued to the shielding layer 50 via a glue layer 611. The light source 63 can include a support 631 and an LED light 633 fixed on the support 631. The support 631 is held on a surface of the flexible printed circuit board 20 away from the conductive pin 231. The LED light 633 is located on one end of the support 631 away from the flexible printed circuit board 20 and the LED light 633 is adjacent to the light guiding plate 61. The LED light 633 can be coupled to the circuit of the circuit layer 21 via an electronic wire which passes through the support 631, and the insulation layer 23, and then couples the LED light 633 with the circuit of the circuit layer 21.

When the handheld electronic device 200 is close to an outer charger, the transmitting coil of the charger can be coupled with the receiving coil 43 of the handheld electronic device 200, and the electric energy of the charger can charge the chargeable battery of handheld electronic device 200

In at least one embodiment, the handheld electronic device 200 can be a personal digital assistant, or other suitable electronic device.

In at least one embodiment, the basement layer 10 can be omitted if a back cover of the handheld electronic device 200 can't influence the receiving coil 43.

In at least one embodiment, the light source 63 can be direct type, that is to say, the light of the LED light 633 can be guided into the light guiding plate 61 from down side thereof.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A handheld electronic device comprising:
a housing, a display screen, and a keypad assembly received in the housing, wherein the keypad assembly comprising:
a flexible printed circuit board;
a plurality of press keys located on the flexible printed circuit board; and
a light guiding module, wherein the light guiding module comprises a light guiding plate and a light source, the light guiding plate is adjacent to the housing and mounted to the plurality of press keys, the light source is electronically coupled to the flexible printed circuit and provides input light for the light guiding plate; the keypad assembly further comprising:
a receiving coil located on the flexible printed circuit board, and surrounding a periphery of the plurality of the press keys and electronically connected to the flexible printed circuit board, wherein the receiving coil transforms electromagnetic waves into power, and charges the handheld electronic device; and
a shielding layer laid on and adhered to the plurality of press keys, wherein the light guiding plate is laid on and adhered to the shielding layers.

2. The handheld electronic device as described in claim 1, wherein the receiving coil is electroplated or etched on the flexible printed circuit board.

3. The handheld electronic device as described in claim 1, wherein the shielding layer comprises a number of sections separated from each other, and when a press is applied on one section of the shielding layer which is corresponding to one press key, the corresponding press key can be pressed with no influence to other press keys.

4. The handheld electronic device as described in claim 3, wherein the shielding layer is an integrated flexible plate, and each press key can be pressed individually with no influence to other press keys.

5. The handheld electronic device as described in claim 1, wherein the flexible printed circuit board comprises a conductive pin, and the conductive pin is coupled to the receiving coil and the press keys respectively.

6. The handheld electronic device as described by claim 5, wherein the shielding layer is laid on and adhere to the plurality of press keys.

7. The handheld electronic device as described by claim 5, wherein the keypad assembly further comprises a basement layer, the basement layer is made of insulating material, and laid on and adhered on a surface of the flexible printed circuit board away from the plurality of press keys.

8. The handheld electronic device as described in claim 6, wherein the light guiding plate is laid on and adhered to the shielding layer, and the light source is located on one side of the light guiding plate.

9. The handheld electronic device as described in claim 8, wherein the light source comprises a support and a LED light fixed on the support, the support is located on one side of flexible printed circuit board, and the LED light is located on one end of the support away from the flexible printed circuit board and adjacent to the light guiding plate.
